(19) United States
(12) Patent Application Publication
(10) Pub. No.: US 2025/0294111 A1
(43) Pub. Date: Sep. 18, 2025

(54) IMAGING CONTROL PROGRAM AND PRINTING SYSTEM

(71) Applicant: SEIKO EPSON CORPORATION, Tokyo (JP)

(72) Inventor: Eishin YOSHIKAWA, Matsumoto (JP)

(21) Appl. No.: 19/078,338

(22) Filed: Mar. 13, 2025

(30) Foreign Application Priority Data
Mar. 15, 2024 (JP) 2024-040735

(51) Int. Cl. H04N 1/60

(52) U.S. Cl. CPC H04N 1/6033

(57) ABSTRACT

An imaging control program causes a computer to realize a determination function of determining whether an imaging condition that causes an imaging section to image an imaging target region including a test pattern is satisfied, and an imaging control function of acquiring a captured image by causing the imaging section to image the imaging target region in response to a trigger that is satisfaction of the imaging condition. The determination function repeatedly acquires the amount of a change in the relative positional relationship between the imaging section and the medium. The imaging condition includes at least first and second conditions to be satisfied, the first condition being a condition that the imaging target region falls within the viewing angle of the imaging section, the second condition being a condition that the acquired amount of the change is smaller than or equal to a reference amount of the change. The determination function determines whether the first condition is satisfied based on frames repeatedly acquired from the imaging section, and determines whether the second condition is satisfied based on the acquired amount of the change.

The present application is based on, and claims priority from JP Application Serial Number 2024-040735, filed Mar. 15, 2024, the disclosure of which is hereby incorporated by reference herein in its entirety.

### BACKGROUND

### 1. Technical Field

The present disclosure relates to an imaging control program for imaging a medium having a test pattern for printing characteristics adjustment, and a printing system.

### 2. Related Art

There is a case where a test pattern used to adjust the printing characteristics of a printing apparatus such as an inkjet printer is read by a scanner.

JP-A-2006-121486 discloses a printing correction method for generating printing correction data by using a digital camera to image a printing correction test pattern printed by a printer.

JP-A-2006-121486 is an example of the related art.

Some printing apparatuses include no scanner, and even when a printing apparatus includes a scanner, some users do not know how to adjust the printing characteristics of the printing apparatus. When a user holds a camera-equipped mobile terminal or the like with his/her hand and images a test pattern, however, it is expected that the test pattern is not properly imaged.

### SUMMARY

A non-transitory computer-readable storage medium storing an imaging control program according to an aspect of the present disclosure is a non-transitory computer-readable storage medium storing an imaging control program for imaging a medium having a test pattern used to adjust printing characteristics of a printing apparatus including a recording head, the program configured to cause a computer to realize
a determination function of determining whether an imaging condition that causes an imaging section to image an imaging target region including the test pattern is satisfied; and
an imaging control function of causing the imaging section to image the imaging target region in response to a trigger that is satisfaction of the imaging condition to acquire a captured image,
wherein the determination function repeatedly acquires an amount of a change in a relative positional relationship between the imaging section and the medium,
the imaging condition includes at least first and second conditions to be satisfied, the first condition being a condition that the imaging target region falls within a viewing angle of the imaging section, the second condition being a condition that the acquired amount of the change is smaller than or equal to a reference amount of the change, and
the determination function determines whether the first condition is satisfied based on frames repeatedly acquired from the imaging section, and determines whether the second condition is satisfied based on the acquired amount of the change.

A printing system according to another aspect of the present disclosure is a printing system including: a printing apparatus including a recording head; and an information terminal configured to image a medium having a test pattern used to adjust printing characteristics of the printing apparatus, wherein
the information terminal includes
an imaging section, and
a control section including a memory configured to store a captured image provided from the imaging section and configured to cause the imaging section to image an imaging target region including the test pattern,
the control section is configured to repeatedly acquire an amount of a change in a relative positional relationship between the imaging section and the medium, determine whether an imaging condition that causes the imaging section to image the imaging target region is satisfied, and cause the imaging section to image the imaging target region in response to a trigger that is satisfaction of the imaging condition to acquire the captured image,
the imaging condition includes at least first and second conditions to be satisfied, the first condition being a condition that the imaging target region falls within a viewing angle of the imaging section, the second condition being a condition that the acquired amount of the change is smaller than or equal to a reference amount of the change, and
the control section is configured to determine whether the first condition is satisfied based on frames repeatedly acquired from the imaging section, and determine whether the second condition is satisfied based on the acquired amount of the change.

### BRIEF DESCRIPTION OF THE DRAWINGS

FIG. 1 diagrammatically shows an example of a printing system.

FIG. 2 diagrammatically shows an example of the configuration of the printing system.

FIG. 3 diagrammatically shows an example of a medium having a test pattern.

FIG. 4 diagrammatically shows an example of the operation of an information terminal that is performing imaging.

FIG. 5 is a flowchart diagrammatically showing an example of imaging control.

FIG. 6 diagrammatically shows an example of whether a first condition is satisfied, the first condition being a condition that an imaging target region falls within the viewing angle of an imaging section.

FIG. 7 diagrammatically shows an example of whether a second condition is satisfied, the second condition being a condition that the amount of a change in the relative positional relationship between the imaging section and the medium is smaller than or equal to a reference amount of the change.

FIG. 8 diagrammatically shows an example of whether a third condition is satisfied, the third condition being a condition that the imaging section falls within a predetermined range over which the imaging section faces the imaging target region.

FIG. 9 diagrammatically shows an example of whether a fourth condition is satisfied, the fourth condition being a condition that the amount of distortion of the test pattern included in frames is smaller than or equal to a reference amount of distortion.

FIG. 10 diagrammatically shows an example of whether a fifth condition is satisfied, the fifth condition being a condition that the length of the interval between the imaging section and the medium is smaller than or equal to a reference length of the interval.

FIGS. 11A and 11B diagrammatically show an example of whether a sixth condition is satisfied, the sixth condition being a condition that the amount of brightness of a ground color of the medium is greater than or equal to a reference magnitude of brightness.

FIG. 12 diagrammatically shows an example of criteria used to determine an imaging condition.

FIG. 13 diagrammatically shows an example of adjustment of printing characteristics.

FIG. 14 is a flowchart diagrammatically showing an example of continuous imaging control.

### DESCRIPTION OF EMBODIMENTS

An embodiment of the present disclosure will be described below. The embodiment below, of course, merely shows an example of the present disclosure, and all the features shown in the embodiment are not necessarily essential to the solution disclosed herein.

### (1) Overview of Aspects Included in Present Disclosure

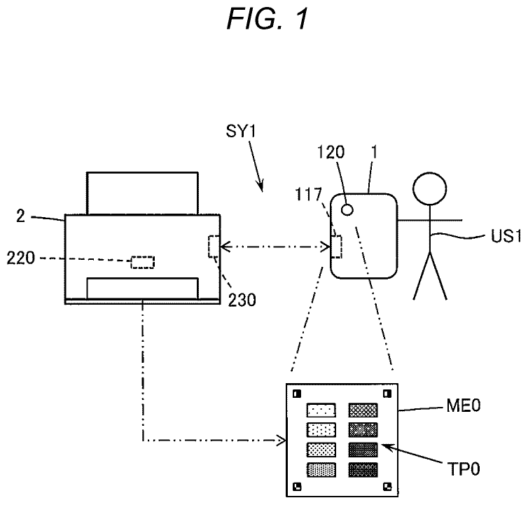

An overview of aspects included in the present disclosure will first be described with reference to examples shown in FIGS. 1 to 14. Note that the figures in the present application diagrammatically show examples, and that the magnification in each direction shown in the figures may vary, so that the figures may not be consistent in magnification. Each element in the aspects of the present disclosure is, of course, not limited to the specific example indicated by the reference character. In “Overview of aspects included in present disclosure”, a term in parentheses means supplementary description of the term immediately before the parentheses.

### First Aspect

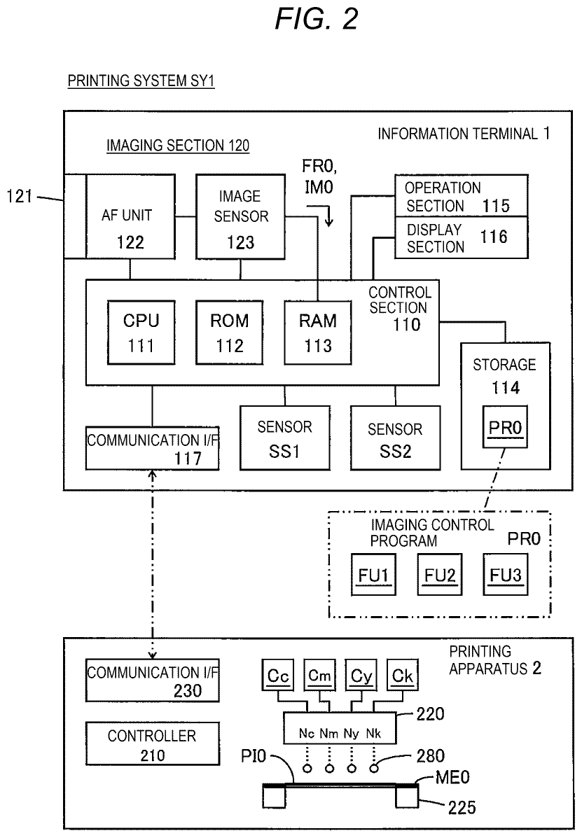

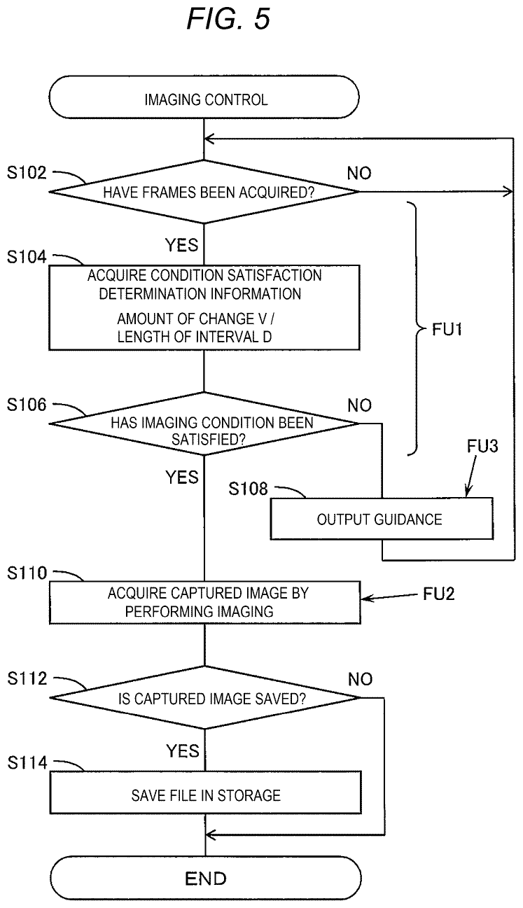

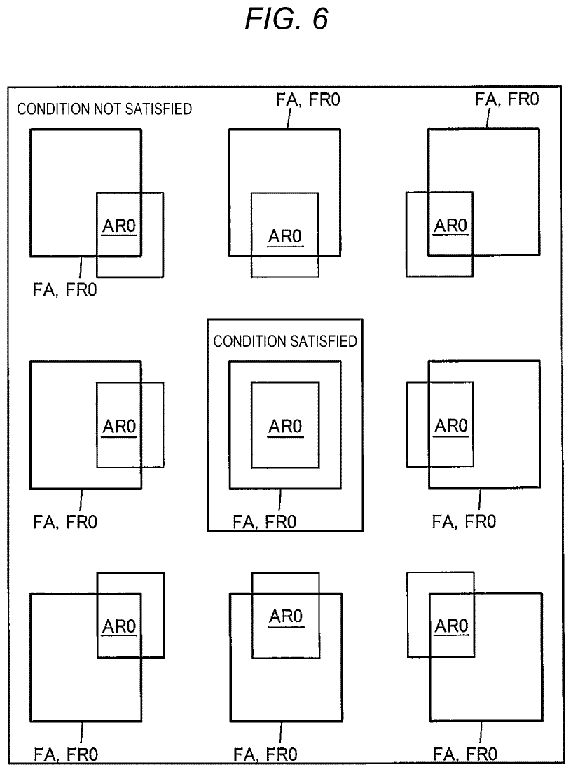

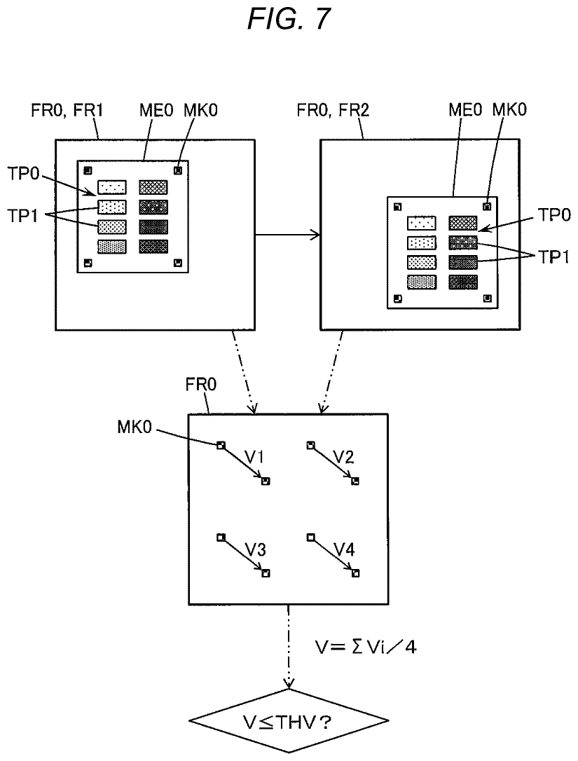

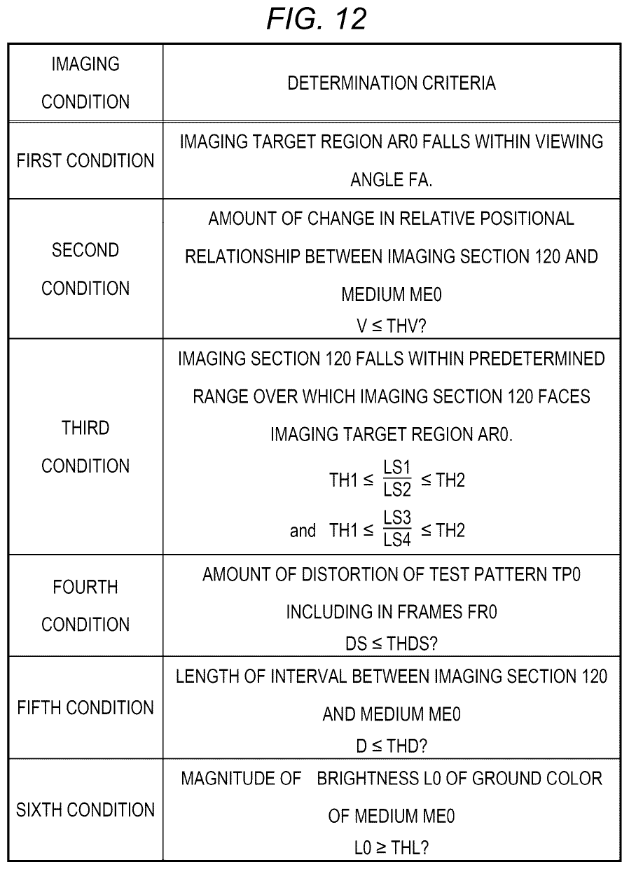

An imaging control program PR0 according to an aspect is a program for imaging a medium ME0 having a test pattern TP0 for adjusting the printing characteristics of a printing apparatus 2 including a recording head 220, and causes a computer (information terminal 1, for example) to realize a determination function FU1 and an imaging control function FU2, as shown in FIGS. 2 and 5 by way of example. The determination function FU1 determines whether an imaging condition (see FIG. 12, for example) under which an imaging section 120 images an imaging target region AR0 including the test pattern TP0 is satisfied. The imaging control function FU2 acquires a captured image IM0 by causing the imaging section 120 to image the imaging target region AR0 in response to a trigger that is satisfaction of the imaging condition. The determination function FU1 repeatedly acquires the amount of a change V in the relative positional relationship between the imaging section 120 and the medium ME0. The imaging condition includes at least first and second conditions to be satisfied, the first condition being a condition that the imaging target region AR0 falls within a viewing angle FA of the imaging section 120 (see FIG. 6, for example), the second condition being a condition that the acquired amount of change V is smaller than or equal to a reference amount of change (threshold THV, for example) (see FIG. 7, for example). The determination function FU1 determines whether the first condition is satisfied based on frames FR0 repeatedly acquired from the imaging section 120, and determines whether the second condition is satisfied based on the acquired amount of the change V.

When the information terminal 1 separate from the printing apparatus 2 is used to image the test pattern TP0, the imaging range may result in an unintended range, or a blurred captured image IM0 may be produced. When the imaging range results in an unintended range or a blurred captured image is produced, the position and color of the test pattern TP0 are not correctly acquired, so that the test pattern TP0 does not function correctly.

In the first aspect described above, the imaging is performed in response to a trigger that is satisfaction of at least a condition that the imaging target region AR0 including the test pattern TP0 falls within the viewing angle FA and the amount of change V in the relative positional relationship between the imaging section 120 and the medium ME0 is small, so that the imaging range is appropriate, and the produced captured image IM0 has a small amount of blur. An appropriate test pattern captured image can thus be used to adjust the printing characteristics. The first aspect described above can therefore provide an imaging control program capable of imaging an appropriate test pattern. As a result, the first aspect described above can prevent a situation in which an unnecessary captured image wastes a certain amount of capacity of the memory.

When it is necessary to perform the operation of pressing or touching a mechanical button or an electric button of the information terminal 1 to release the shutter, there is a possibility of an image blur or the like due to the button operation. Performing the imaging in response to a trigger that is satisfaction of the imaging condition can prevent the image blur or the like due to the button operation.

Various examples of the aspect described above are conceivable.

Examples of the printing characteristics may include the density of a print image, the position where each droplet lands, the transportation length of a medium, and the droplet discharge state at each nozzle.

Examples of the test pattern may include a density pattern used to adjust the density of a print image, a Bi-d adjustment pattern used to perform Bi-d adjustment (bidirectional adjustment) for aligning the droplet landing positions in the forward and backward paths with each other, a transportation length adjustment pattern used to adjust the transportation length of a medium on which a print image is formed, and a nozzle check pattern indicating the droplet discharge state at each nozzle of the recording head.

Examples of the imaging target region may include the entire medium and a region defined by multiple position detection patterns.

Acquiring a captured image may be storing a captured image provided from the imaging section in a memory, or may be controlling a direct memory access (DMA) controller to cause it to store the captured image in a memory. The storage in the memory includes storage in a random access memory (RAM) and storage in a nonvolatile memory.

The frame means an image indicated by a signal output from the imaging section on a frame period basis.

Examples of the amount of a change in the relative positional relationship between the imaging section and the medium may include the amount of movement of the medium between frames, the speed detected by a speed sensor, and the acceleration detected by an acceleration sensor.

The viewing angle means the imaging range.

In the present application, “first”, “second”, and so on are terms used to identify each of multiple elements having similarities, and do not mean the order of the elements.

The additional remarks described above, of course, also apply to the following aspects.

### Second Aspect

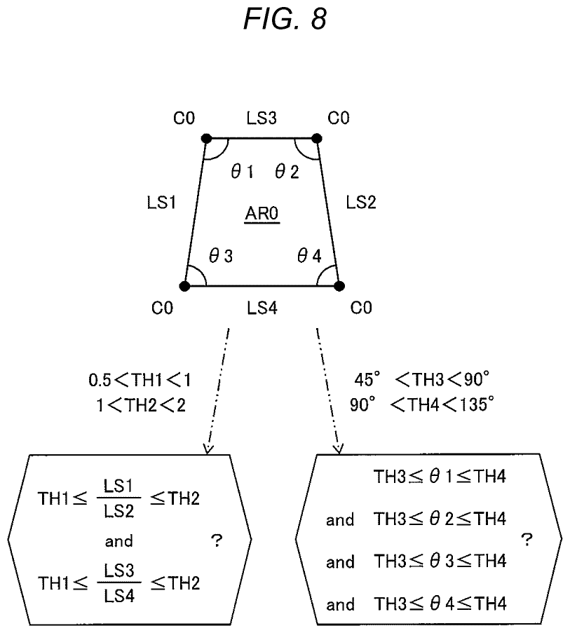

The imaging condition may include at least the first condition, the second condition, and a third condition to be satisfied, the third condition being a condition that the imaging section 120 falls within a predetermined range over which the imaging section 120 faces the imaging target region AR0 (see FIG. 8, for example). The determination function FU1 may determine whether the third condition is satisfied based on the shape of the imaging target region AR0 included in any of the frames FR0.

When the imaging section 120 does not fall within the range over which the imaging section 120 faces the test pattern TP0, the resolution differs in the test pattern TP0 between the side close to the imaging section 120 and the side far from the imaging section 120, and the resultant adjustment values may differ between the side close to the imaging section 120 and the side far from the imaging section 120. In the second aspect, since the imaging is performed in response to a trigger that is satisfaction of the imaging condition including the condition that the imaging section 120 falls within the range over which the imaging section 120 faces the test pattern TP0, a more appropriate test pattern captured image can be used to adjust the characteristics of printing. The second aspect described above can therefore provide an imaging control program capable of imaging a further appropriate test pattern.

### Third Aspect

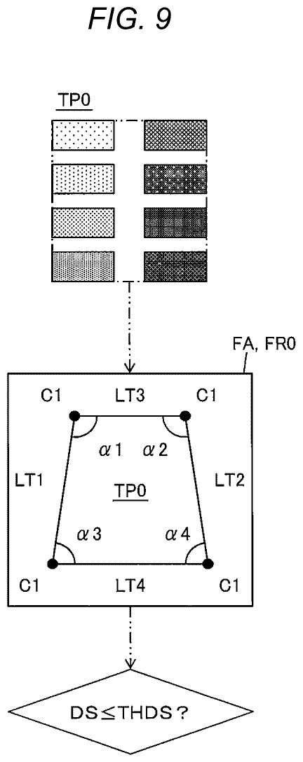

The imaging condition may include at least the first condition, the second condition, and a fourth condition to be satisfied, the fourth condition being a condition that the amount of distortion DS indicating distortion of the test pattern TP0 included in each of the frames FR0 is smaller than or equal to a reference amount of the distortion (threshold THDS, for example) (see FIG. 9, for example). The determination function FU1 may determine whether the fourth condition is satisfied based on the shape of the test pattern TP0 included in the frame FR0.

When the test pattern TP0 is greatly distorted, the adjustment values may change in accordance with the position of the test pattern TP0. In the third aspect described above, since the imaging is performed in response to a trigger that is satisfaction of the imaging condition including the condition that the amount of distortion DS of the test pattern TP0 included in the frame FR0 is small, a more appropriate test pattern captured image can be used to adjust the characteristics of printing. The third aspect described above can therefore provide an imaging control program capable of imaging a further appropriate test pattern.

### Fourth Aspect

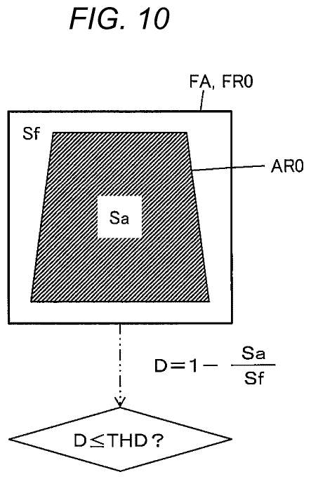

The determination function FU1 may repeatedly detect the length of an interval D corresponding to the interval between the imaging section 120 and the medium ME0. The imaging condition may include at least the first condition, the second condition, and a fifth condition to be satisfied, the fifth condition being a condition that the length of the interval D is smaller than or equal to a reference length of the interval (threshold THD, for example) (see FIG. 10, for example). The determination function FU1 may determine whether the fifth condition is satisfied based on the detected length of the interval D.

When the imaging section 120 is too far from the medium ME0, the resolution of the imaged test pattern TP0 decreases, so that the adjustment values have large errors. In the fourth aspect described above, since the imaging is performed in response to a trigger that is satisfaction of the imaging condition including the condition that the length of the interval D between the imaging section 120 and the medium ME0 is smaller than or equal to the reference length of the interval (THD), a more appropriate captured test pattern image can be used to adjust the printing characteristics. The fourth aspect described above can therefore provide an imaging control program capable of imaging a further appropriate test pattern.

Examples of the length of the interval may include the distance from the imaging section to the medium such as a distance detected by a distance measuring sensor, and an amount using the ratio of the area of the imaging target region in a frame to the area of the frame. The additional remark described above, of course, also applies to the following aspects.

### Fifth Aspect

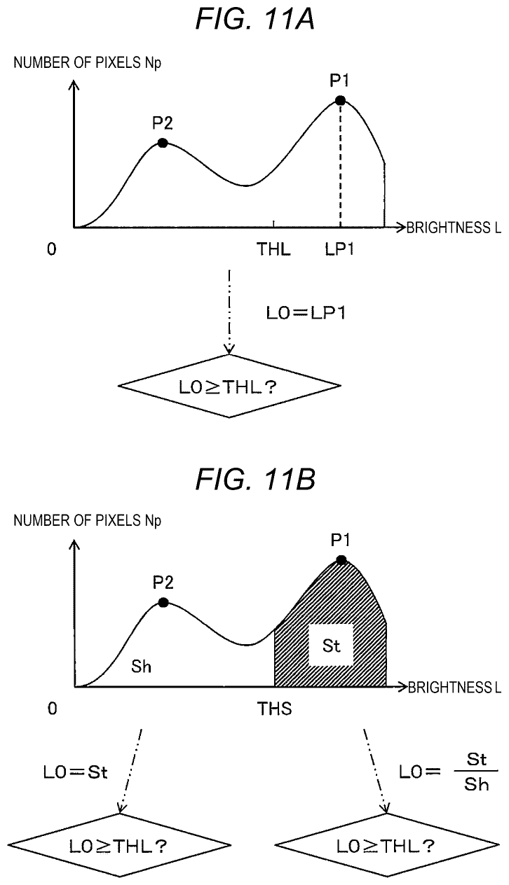

The determination function FU1 may acquire the magnitude of brightness L0, which indicates brightness L of the ground color of the medium ME0, based on each of the frames FR0. The imaging condition may include at least the first condition, the second condition, and a sixth condition to be satisfied, the sixth condition being a condition that the magnitude of the brightness L0 is greater than or equal to a reference magnitude of the brightness (threshold THL, for example) (see FIGS. 11A and 11B, for example). The determination function FU1 may determine whether the sixth condition is satisfied based on the acquired magnitude of the brightness L0.

For example, when the captured image IM0 is dark due, for example, to the effect of a shadow, the density of the captured test pattern TP0 increases, resulting in incorrect acquisition of the colors or other factors of the test pattern TP0. In the fifth aspect described above, since the imaging is performed in response to a trigger that is satisfaction of the imaging condition including the condition that the magnitude of the brightness L0 of the ground color of the medium ME0 is greater than or equal to the reference magnitude of the brightness (THL), a more appropriate captured test pattern image can be used to adjust the printing characteristics. The fifth aspect described above can therefore provide an imaging control program capable of imaging a further appropriate test pattern.

### Sixth Aspect

The imaging condition may include at least the first condition, the second condition, a third condition, a fourth condition, a fifth condition, and a sixth condition to be satisfied, the third condition being a condition that the imaging section 120 falls within a predetermined range over which the imaging section 120 faces the imaging target region AR0, the fourth condition being a condition that the amount of distortion DS indicating distortion of the test pattern TP0 included in each of the frames FR0 is smaller than or equal to a reference amount of the distortion (threshold THDS, for example), the fifth condition being a condition that the length of the interval D is smaller than or equal to a reference length of the interval (threshold THD, for example), and the sixth condition being a condition that the magnitude of the brightness L0 is greater than or equal to a reference magnitude of the brightness (threshold THL, for example). The determination function FU1 may determine whether the third condition is satisfied based on the shape of the imaging target region AR0 included in any of the frames FR0, may determine whether the fourth condition is satisfied based on the shape of the test pattern TP0 included in the frame FR0, may repeatedly detect the length of an interval D corresponding to the interval between the imaging section 120 and the medium ME0 to determine whether the fifth condition is satisfied based on the detected length of the interval D, may acquire the magnitude of brightness L0, which indicates brightness L of the ground color of the medium ME0, based on each of the frames FR0 to determine whether the sixth condition is satisfied based on the acquired magnitude of the brightness L0.

An imaging control program capable of imaging a more appropriate test pattern can be provided by combining the multiple conditions with each other.

### Seventh Aspect

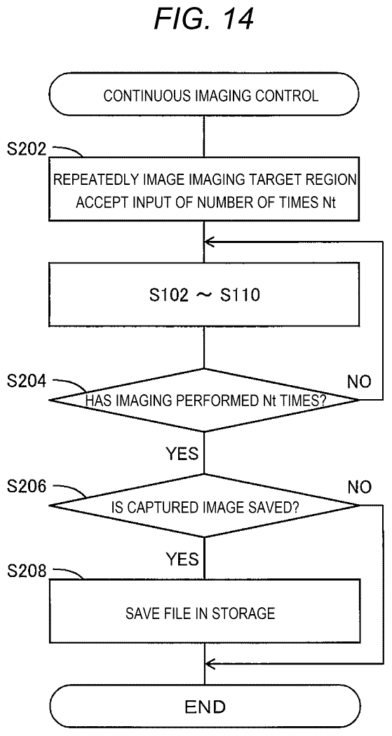

The imaging control function FU2 may accept an input of the number of times Nt the imaging target region AR0 is repeatedly imaged, as shown in FIG. 14 by way of example. The imaging control function FU2 may cause the imaging section 120 to repeatedly image the imaging target region AR0 the number of times Nt when the imaging condition is satisfied.

In this case, since an appropriate captured test pattern image is produced multiple times, the printing characteristics can be more appropriately adjusted.

### Eighth Aspect

The imaging control program PR0 in the present embodiment may cause the computer (1) to further realize a guidance 1 function FU3 of outputting, when any of the multiple conditions included in the imaging condition is not satisfied, guidance for satisfying the unsatisfied condition, as shown in FIG. 5 by way of example.

In this case, since the guidance for satisfying the imaging condition is output, the medium ME0 can be smoothly imaged. In particular, since the guidance for satisfying the unsatisfied condition out of the multiple conditions included in the imaging condition is output, the eighth aspect described above can prevent a situation in which a user unnecessarily moves the imaging section 120 to satisfy any of the already satisfied conditions. As a result, the time required before the imaging can be shortened.

### Ninth Aspect

A printing system SY1 according to an aspect includes the printing apparatus 2 including the recording head 220, and the information terminal 1, which images the medium ME0 having the test pattern TP0 used to adjust the printing characteristics of the printing apparatus 2, as shown in FIGS. 1 and 2 by way of example. The information terminal 1 includes the imaging section 120 and a control section 110, which includes the memory (RAM 113, for example) that stores the captured image IM0 provided from the imaging section 120 and causes the imaging section 120 to image the imaging target region AR0 including the test pattern TP0. The control section 110 repeatedly acquires the amount of the change V in the relative positional relationship between the imaging section 120 and the medium ME0, determines whether the imaging condition, which is a trigger causing the imaging section 120 to image the imaging target region AR0, is satisfied, and acquires the captured image IM0 by causing the imaging section 120 to image the imaging target region AR0 in response to the trigger, which is satisfaction of the imaging condition. The imaging condition includes at least first and second conditions to be satisfied, the first condition being a condition that the imaging target region AR0 falls within the viewing angle FA of the imaging section 120, the second condition being a condition that the acquired amount of the change V is smaller than or equal to the reference amount of the change (THV). The control section 110 determines whether the first condition is satisfied based on the frames FR0 repeatedly acquired from the imaging section 120, and determines whether the second condition is satisfied based on the acquired amount of the change V.

The ninth aspect described above can provide a printing system capable of imaging an appropriate test pattern.

Furthermore, the aspects described above are applicable to a non-transitory computer-readable medium on which the imaging control program described above is recorded, the information terminal described above, a method for controlling the information terminal, a printing method performed by the printing system described above, a program that controls the printing system described above, a non-transitory computer-readable medium on which the control program is recorded, and the like. Any of the apparatuses described above may be configured with multiple dispersed portions.

### (2) Specific Example of Imaging Control Program

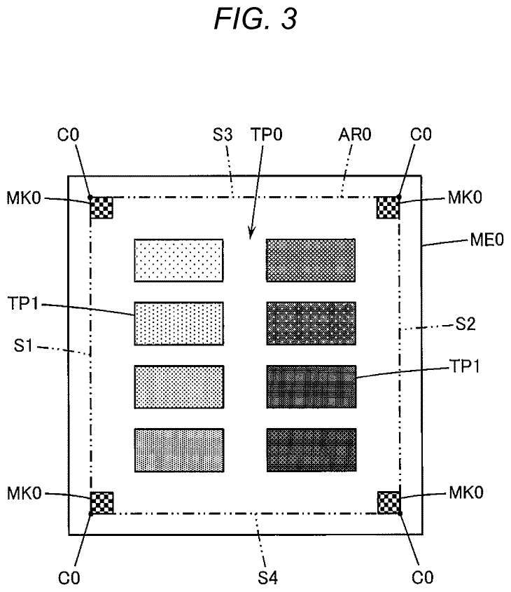

FIG. 1 diagrammatically shows the printing system SY1 including the information terminal 1 and the printing apparatus 2 by way of example. FIG. 2 diagrammatically shows the configuration of the printing system SY1 by way of example. FIG. 3 diagrammatically shows the medium ME0 having the test pattern TP0 by way of example.

Examples of the information terminal 1 may include a mobile phone such as a smartphone, a tablet terminal, and the like. The information terminal 1 may be configured with multiple apparatuses divided so as to be capable of communicating with each other, or may be a stationary apparatus to which an imaging section is so coupled that the position thereof is changeable. The printing apparatus 2 is assumed to be an inkjet printer including the recording head 220 capable of discharging droplets 280. The printing apparatus 2 may, of course, be a thermal printer (including thermal transfer printer) including a thermal head as the recording head, an electrophotographic printer (laser printer, for example) including a recording head that causes toner to adhere to the medium ME0, a three-dimensional printer, or the like. The printing apparatus 2 may be configured with multiple apparatuses divided so as to be capable of communicating with each other.

The printing apparatus 2 can form a print image PI0 on the medium ME0, the print image PI0 including the test pattern TP0 used to adjust the printing characteristics of the printing apparatus 2. A user US1 can adjust the printing characteristics of the printing apparatus 2 by using the information terminal 1 including the imaging section 120 to image the test pattern TP0. When the user US1 images the test pattern TP0 while holding the information terminal 1 with his/her hand, a portion of the test pattern TP0 may extend off the viewing angle, that is, the imaging range of the imaging section 120, a blurred captured image may be produced, the test pattern TP0 may be inclined, the test pattern TP0 may be too far from the imaging section 120, or the imaging environment may be too dark. Furthermore, when it is necessary to press a button of the information terminal 1 to release the shutter, there is a possibility of an image blur or the like due to the button operation. To address the problems described above, the imaging control program PR0 shown in FIG. 2 causes the information terminal 1 to image an appropriate test pattern TP0 by causing the imaging section 120 to automatically perform the imaging in response to a trigger that is satisfaction of the imaging condition. It can be said that the information terminal 1, which executes the imaging control program PR0, realizes an automatic shutter system.

Even when the information terminal 1 is not a portable apparatus and is a stationary apparatus, the imaging control program PR0 may be executed, for example, when image blur occurs or the relative positional relationship between the information terminal 1 and the test pattern TP0 changes.

A communication interface (I/F) 117 of the information terminal 1 can communicate with a communication I/F 230 of the printing apparatus 2. The information terminal 1 can transmit printing characteristic adjustment values and the like to the printing apparatus 2 via the communication I/Fs 117 and 230. Upon reception of the adjustment values, the printing apparatus 2 stores the adjustment values and adjusts the printing characteristics based on the adjustment values. The communication via the communication I/Fs 117 and 230 may be wireless communication compliant, for example, with a wireless local area network (LAN) standard, wired communication, or network communication such as the Internet.

The information terminal 1 shown in FIG. 2 includes the control section 110, a storage 114, an operation section 115, a display section 116, the communication I/F 117, and the imaging section 120. The information terminal 1 m sensors SS1 and SS2 coupled to the control section 110. The control section 110 includes a central processing unit (CPU) 111, which is a processor, a read only memory (ROM) 112, and a random access memory (RAM) 113. The RAM 113 is an example of the memory that stores the captured image IM0 provided from the imaging section 120.

The storage 114 stores, for example, the imaging control program PR0 used to image the medium ME0 having the test pattern TP0. The storage 114 can, for example, be a nonvolatile semiconductor memory such as a flash memory. The storage 114 may be detachably attached to a main body of the information terminal 1. The display section 116 displays, based on display information, a screen corresponding to the display information. The display section 116 can, for example, be a liquid crystal display panel. The operation section 115 can be a touch panel attached to the surface of the display section 116, hardware keys, or the like.

The imaging control program PR0 causes the information terminal 1 to realize the determination function FU1, the imaging control function FU2, and the guidance function FU3. The CPU 111 reads information stored in the storage 114 as appropriate into the RAM 113 and executes the read program to carry out various processes. The CPU 111 executes the imaging control program PR0 read into the RAM 113 to carry out processes corresponding to the functions (FU1 to FU3) described above. The information terminal 1 that executes the imaging control program PR0 executes a determination step corresponding to the determination function FU1, an imaging control step corresponding to the imaging control function FU2, and a guidance step corresponding to the guidance function FU3. The computer-readable medium that stores the imaging control program PR0, which causes the computer to realize the functions (FU1 to FU3) described above, is not limited to the storage 114, and may be a recording medium external to the information terminal 1.

The imaging section 120 includes a lens 121, an autofocus (AF) unit 122, an image sensor 123, and the like. The image sensor 123 converts an image of light incident via the lens 121 and the AF unit 122 into an electric signal. It is assumed that the image sensor 123 in the present specific example outputs digital data corresponding to the electric signal from each light receiving element. The digital data is stored in the RAM 113 as the frames FR0 or the captured image IM0. The image sensor 123 can be a complementary metal-oxide semiconductor (CMOS) image sensor, a charge coupled device (CCD) image sensor, or the like.

The sensors SS1 and SS2 can be used to determine whether the imaging condition is satisfied. For example, the sensor SS1 may be a speed sensor that measures the moving speed of the imaging section 120 or an acceleration sensor that measures acceleration acting on the imaging section 120. In this case, the magnitude of the blur of the captured image IM0 can be detected based on a value measured by the sensor SS1. The sensor SS2 may be a distance measuring sensor that measures the distance from the imaging section 120 to the medium ME0. In this case, the distance from the imaging section 120 to the medium ME0 can be detected based on a value measured by the sensor SS2.

The printing apparatus 2 ejects C (cyan) ink, M (magenta) ink, Y (yellow) ink, and K (black) ink as color materials from the recording head 220 in the form of the droplets 280 to form the print image PI0 corresponding to print data. The recording head 220 includes multiple nozzles Nc capable of discharging C ink droplets to the medium ME0, multiple nozzles Nm capable of discharging M ink droplets to the medium ME0, multiple nozzles Ny capable of discharging Y ink droplets to the medium ME0, and multiple nozzles Nk capable of discharging K ink droplets to the medium ME0. The C, M, Y, and K inks are supplied from ink cartridges Cc, Cm, Cy, and Ck, respectively, to the recording head 220. The recording head 220 discharges the C, M, Y, and K droplets 280 from the nozzles Nc, Nm, Ny, and Nk, respectively, under the control of a controller 210. The droplets 280 each land on the medium ME0 to form an ink dot on the medium ME0. The printing apparatus 2 further includes a driver that changes the relative positional relationship between the recording head 220 and the medium ME0 under the control of the controller 210, for example, a transporting section 225, which transports the medium ME0 in a predetermined transportation direction. As a result, a printed matter configured with the medium ME0 having a pattern of the ink dots as the print image PI0 is produced. The medium ME0 is not necessarily made of a specific material and may be made, for example, of paper, fabric, resin, or metal. The medium ME0 may have a two-dimensional shape of a cut sheet, a rolled shape, or a three-dimensional shape.

The medium ME0 shown in FIG. 3 has the test pattern TP0 including multiple individual patterns TP1, and multiple position detection patterns MK0. The test pattern TP0 may, for example, be the density pattern, the Bi-d adjustment pattern, the transportation length adjustment pattern, or the nozzle check pattern. The position detection patterns MK0 are disposed on the medium ME0 at corners C0 of a rectangle including the test pattern TP0. When the position detection patterns MK0 are disposed at the four corners of the rectangle, the imaging target region AR0 including the test pattern TP0 is a rectangular region having the corners C0, which are the position detection patterns MK0, on the medium ME0. In FIG. 3, the rectangular imaging target region AR0 having vertical sides S1 and S2 and horizontal sides S3 and S4 is indicated by a two-dot chain line. The position detection patterns MK0 can each be a square ArUco marker having a specific geometric feature, a triangular pattern, or the like.

When the position detection patterns MK0 are not present on the medium ME0, the medium ME0 itself is the imaging target region AR0. In this case, the medium ME0 is preferably cut like a cut sheet, and preferably has a rectangular shape although not limited thereto.

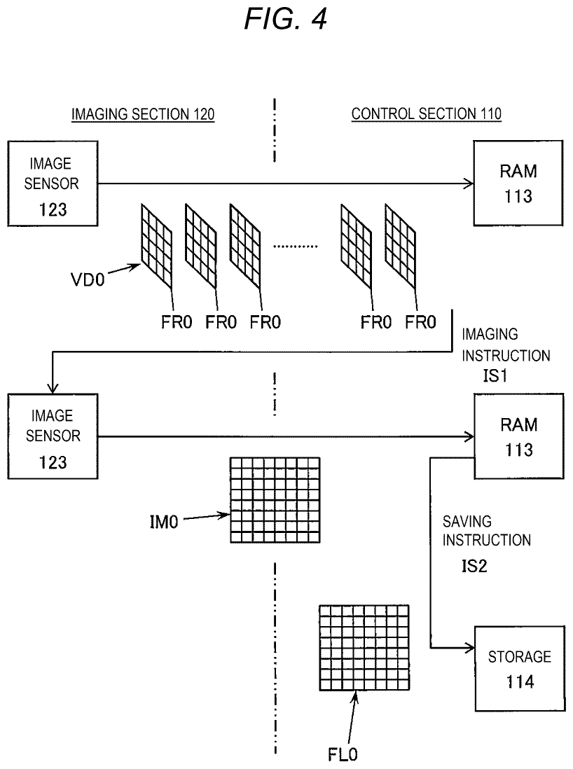

An example of the operation of the information terminal 1 that is performing imaging will next be described with reference to FIG. 4. The imaging is performed in response to a trigger that is the operation of pressing a shutter button provided in the operation section 115.

The frames FR0, which constitute a video VD0, are transferred from the image sensor 123 of the imaging section 120 to the RAM 113 of the control section 110 on a frame period basis. In this process, the CPU 111 may store the frames FR0 in the RAM 113, or the DMA controller, which is not shown, may store the frames FR0 in the RAM 113. The frames FR0 each represent a still image in each frame period, and may differ in information from the previous frame. Due to the processing performance of the information terminal 1, the frames FR0 each have resolution lower than that of the captured image IM0. It can also be said that the frames FR0 each have a smaller number of pixels than the captured image IM0. The control section 110 controls the AF unit 122 and other sections based on the group of the frames FR0. The control section 110 may cause the display section 116 to display each of the frames FR0.

When the user US1 performs the operation of pressing or touching the shutter button, the operation section 115 accepts the operation, and the operation section 115 notifies the control section 110 that the shutter button has been operated. The control section 110 then issues an imaging instruction IS1 to the imaging section 120 to cause the imaging section 120 to perform imaging. The captured image IM0 generated by the imaging has resolution higher than the frames FR0, and is stored in the RAM 113. Also in this process, the CPU 111 may store the captured image IM0 in the RAM 113, or the DMA controller, which is not shown, may store the captured image IM0 in the RAM 113.

When the user US1 performs the operation of saving the captured image IM0, the operation section 115 accepts the operation, and the operation section 115 notifies the control section 110 of a saving instruction IS2. The control section 110 then changes the formant of the captured image IM0 to the format of a file FL0 and saves the resultant captured image IM0 in the storage 114. That is, the storage 114 stores the file FL0. Examples of the file format may include the joint photographic experts group (JPEG) format and the bitmap format. Note that the control section 110 may accept settings such as the file format and the resolution of the captured image IM0 included in the file FL0 via the operation section 115 and save the file FL0 according to the settings in the storage 114. The control section 110 may instead automatically generate the file FL0 of the captured image IM0 in response to a trigger that is the storage of the captured image IM0 in the RAM 113, and store the generated file FL0 in the storage 114.

Note, however, that the button operation for the imaging may cause, for example, an image blur. Therefore, in the present specific example, the imaging is automatically performed in response to a trigger that is satisfaction of the imaging condition.

### (3) Specific Example of Imaging Control

FIG. 5 diagrammatically shows an example of the imaging control performed by the control section 110. In FIG. 5, steps S102 to S106 correspond to the determination function FU1, step S108 corresponds to the guidance function FU3, and step S110 corresponds to the imaging control function FU2. Hereinafter, the description of “step” may be omitted, and the reference characters of the steps may be shown in parentheses. The imaging control starts when the control section 110 accepts the imaging instruction that instructs imaging the imaging target region AR0 via the operation section 115. The imaging instruction may be an operation performed on an imaging instruction region displayed after the imaging control program PR0 is activated, an operation performed on the shutter button, the operation of activating the imaging control program PR0, or the like. FIGS. 6 to 12 diagrammatically show an example of each of the conditions included in the imaging condition.

When the imaging control starts, the control section 110 determines whether a new frame FR0 has been transferred from the image sensor 123 to the RAM 113 (S102). The determination process in S102 is repeated until the new frame FR0 is transferred. It can also be said that the determination process in S102 is the process of determining whether the new frame FR0 has been acquired from the imaging section 120.

When the new frame FR0 is transferred, the control section 110 acquires condition satisfaction determination information used to determine whether the imaging condition that is a trigger causing the imaging section 120 to image the imaging target region AR0 including the test pattern TP0 is satisfied (S104). The condition satisfaction determination information includes the amount of the change V in the relative positional relationship between the imaging section 120 and the medium ME0 and the length of the interval D corresponding to the interval between the imaging section 120 and the medium ME0. The condition satisfaction determination information will be described later in detail.

After acquiring the condition satisfaction determination information, the control section 110 determines whether the imaging condition is satisfied based on the frames FR0 and the condition satisfaction determination information (S106). When the imaging condition is not satisfied, the control section 110 outputs guidance for satisfying the unsatisfied condition (S108), and returns to the process in S106. Accordingly, the processes in S102 to S108 are repeated until the imaging condition is satisfied, and the control section 110 repeatedly acquires the frames FR0 from the imaging section 120 and repeatedly acquires the condition satisfaction determination information. The output of the guidance may, for example, displayed on the display section 116, or verbal output from a voice output section that is not shown. The processes in S106 and S108 will be described later in detail.

When the imaging condition is satisfied, the control section 110 causes the imaging section 120 to image the imaging target region AR0 to acquire the captured image IM0 (S110). At this point in time, the CPU 111 may store the captured image IM0 from the image sensor 123 in the RAM 113, or the DMA controller may store the captured image IM0 from the image sensor 123 in the RAM 113. The captured image IM0 has resolution higher than the frames FR0.

The control section 110 thus acquires the captured image IM0 by causing the imaging section 120 to image the imaging target region AR0 in response to a trigger that is satisfaction of the imaging condition.

After acquiring the captured image IM0, the control section 110 determines whether to save the captured image IM0 as the file FL0 (S112). For example, when the operation section 115 accepts the operation of saving the captured image IM0, the control section 110 changes the format of the captured image IM0 to the format of the file FL0, saves the resultant captured image IM0 in the storage 114 (S114), and terminates the imaging control. That is, the storage 114 stores the file FL0. When the operation section 115 accepts the operation of discarding the captured image IM0, the control section 110 terminates the imaging control without carrying out the saving process in S114.

In S112, the control section 110 may determine whether the test pattern TP0 included in the captured image IM0 is appropriate for adjustment of the printing characteristics. In this case, the control section 110 may perform the saving process in S114 when the control section 110 has determined the test pattern TP0 is appropriate, or may return to the process in S102 when the control section 110 has determined the test pattern TP0 is inappropriate. The reason for this is that there is a time lag before actual imaging even when the imaging condition is satisfied. The control section 110 may further automatically generate the file FL0 of the captured image IM0 and store the file FL0 in the storage 114 in response to a trigger that is the storage of the captured image IM0 in the RAM 113 by carrying out the process in S114 without carrying out the determination process in S112.

The processes in steps S104 to S108 will next be described in detail.

FIG. 6 diagrammatically shows an example of whether the first condition is satisfied, the first condition being a condition that the imaging target region AR0 falls within the viewing angle FA of the imaging section 120. Whether the first condition is satisfied can be determined by determining whether the imaging target region AR0 is completely included in the frames FR0 corresponding to the viewing angle FA.

For example, it is assumed that the medium ME0 has the position detection patterns MK0 at the four corners of the imaging target region AR0. In this case, the control section 110 can determine that the first condition is satisfied when four position detection patterns MK0 can be detected from the frames FR0. The control section 110 can further determine that the first condition is not satisfied when even one of the four position detection patterns MK0 cannot be detected from the frames FR0.

When the medium ME0 does not have the position detection patterns MK0, the medium ME0 itself is the imaging target region AR0. When the medium ME0 has a rectangular shape, the control section 110 can detect multiple edges from the frames FR0 and determine that the first condition is satisfied when the control section 110 can detect a quadrangle surrounded by two edges determined to be vertically oriented and two edges determined to be horizontally oriented. Since the medium ME0 included in the frames FR0 may be inclined, the term “vertically orientated” should include the strict vertical direction and a predetermined allowable angular range therearound, and the term “horizontally orientated” should include the strict horizontal direction and a predetermined allowable angular range therearound. Known quadrangle recognition such as business card recognition is applicable to the recognition of the medium ME0 from the frames FR0.

As described above, the control section 110 determines whether the first condition is satisfied based on the frames FR0 repeatedly acquired from the imaging section 120. When the first condition is not satisfied, the control section 110 outputs guidance for satisfying the first condition in S108 shown in FIG. 5. As an example of the output of the guidance, “Please put the entire test pattern in the screen.”, or any other piece of information may be displayed or verbally output.

FIG. 7 diagrammatically shows an example of whether the second condition is satisfied, the second condition being a condition that the amount of the change V in the relative positional relationship between the imaging section 120 and the medium ME0 is smaller than or equal to the threshold THV. The threshold THV is an example of the reference amount of the change and is a positive value.

The control section 110 repeatedly acquires the frames FR0 from the imaging section 120. Hereinafter, the last acquired frame FR0 is called a “last frame FR1”, and the currently acquired frame FR0 is called a “current frame FR2”. The control section 110 may acquire, as the amount of the change V, a distance between a feature point included in the last frame FR1 and the feature point included the current frame FR2 as a result of movement of the feature point included in the last frame FR1 to the feature point included the current frame FR2. Examples of the feature point may include any of the position detection patterns MK0 and any of the corners of any of the individual patterns TP1. When there are multiple feature points, the control section 110 may acquire the average of multiple travels determined for the multiple feature points as the amount of the change V. FIG. 7 shows that travels V1, V2, V3, and V4 of the four position detection patterns MK0 are determined based on the last frame FR1 and the current frame FR2, and that the amount of the change V is acquired by averaging the travels Vi.

When the information terminal 1 includes the sensor SS1, for example, a speed sensor or an acceleration sensor, the control section 110 may acquire a value detected by the sensor SS1, for example, a speed value or an acceleration value as the amount of the change V. In this case, it is assumed that the medium ME0 is stationary.

The control section 110 can determine whether the second condition is satisfied based on the acquired amount of the change V. When the amount of the change V is smaller than or equal to the threshold THV, the control section 110 determines that the second condition is satisfied. When the amount of the change V is greater than the threshold THV, the control section 110 determines that the second condition is not satisfied.

When the second condition is not satisfied, the control section 110 outputs guidance for satisfying the second condition in S108 shown in FIG. 5. As an example of the output of the guidance, “Please try not to shake the camera.”, or any other piece of information may be displayed or verbally output.

FIG. 8 diagrammatically shows an example of whether the third condition is satisfied, the third condition being a condition that the imaging section 120 falls within a predetermined range over which the imaging section 120 faces the imaging target region AR0. FIG. 8 shows the shape of the imaging target region AR0 included in the frames FR0. The control section 110 can determine whether the third condition is satisfied based on the shape of the imaging target region AR0 included in the frames FR0.

The control section 110 determines whether the imaging target region AR0 is included in the frames FR0, as described above. When the imaging target region AR0 has a rectangular shape and the imaging target region AR0 is included in the frames FR0, the control section 110 can determine the intervals between adjacent corners C0 based on the frames FR0. FIG. 8 shows a length LS1 corresponding to the vertical side S1 (see FIG. 3), a length LS2 corresponding to the vertical side S2 (see FIG. 3), a length LS3 corresponding to the horizontal side S3 (see FIG. 3), and a length LS4 corresponding to the horizontal side S4 (see FIG. 3). The fact that the imaging section 120 falls within the predetermined range over which the imaging section 120 faces the imaging target region AR0 means that the difference between the length LS1 of the vertical side S1 and the length LS2 of the vertical side S2 is small and the difference between the length LS3 of the horizontal side S3 and the length LS4 of the horizontal side S4 is small. To quantitatively define the range over which the imaging section 120 faces the imaging target region AR0, thresholds TH1 and TH2 are applied to a vertical side length ratio LS1/LS2 and a horizontal side length ratio LS3/LS4. Threshold TH1 is a positive value smaller than one, and 0.5<TH1<1 is satisfied in the example shown in FIG. 8. It can be said that the threshold TH1 closer to one indicates that the imaging section 120 faces the imaging target region AR0 by a greater degree. Threshold TH2 is greater than one, and 1<TH2<2 is satisfied in the example shown in FIG. 8. It can be said that the threshold TH2 closer to one indicates that the imaging section 120 faces the imaging target region AR0 by a greater degree. When the imaging section 120 falls within the predetermined range over which the imaging section 120 faces the imaging target region AR0, that is, TH1≤LS1/LS2≤TH2 and TH1≤LS3/LS4≤TH2 are satisfied, the control section 110 determines that the third condition is satisfied. When LS1/LS2<TH1, LS1/LS2>TH2, LS3/LS4<TH1, or LS3/LS4>TH2 is satisfied, the control section 110 determines that the third condition is not satisfied.

The length ratios LS1/LS2 and LS3/LS4 can, of course, be replaced with percentages expressed by 100×LS1/LS2 (%) and 100×LS3/LS4 (%).

The control section 110 may determine angles θ1, θ2, θ3, and θ4 of the four corners C0 of the imaging target region AR0 based on the frames FR0. The fact that the imaging section 120 falls within the predetermined range over which the imaging section 120 faces the imaging target region AR0 means that the angles θ1, θ2, θ3, and θ4 are all 90° or in the vicinity thereof. To quantitatively define the range over which the imaging section 120 faces the imaging target region AR0, thresholds TH3 and TH4 are applied to the angles θ1, θ2, θ3, and θ4. The threshold TH3 is a positive value smaller than 90°, and 45°<TH3<90° is satisfied in the example shown in FIG. 8. It can be said that the threshold TH3 closer to 90° indicates that the imaging section 120 faces the imaging target region AR0 by a greater degree. The threshold TH4 is a value greater than 90°, and 90°<TH4<135° is satisfied in the example shown in FIG. 8. It can be said that the threshold TH4 closer to 90° indicates that the imaging section 120 faces the imaging target region AR0 by a greater degree. When the imaging section 120 falls within the predetermined range over which the imaging section 120 faces the imaging target region AR0, that is, TH3≤θ1≤TH4, TH3≤θ2≤TH4, TH3≤θ3≤TH4, and TH3≤θ4≤TH4 are satisfied, the control section 110 determines that the third condition is satisfied. When θ1<TH3, θ1>TH4, θ2<TH3, θ2>TH4, θ3<TH3, θ3>TH4, θ4<TH3, or θ4>TH4 is satisfied, the control section 110 determines that the third condition is not satisfied.

Note that the control section 110 may determine that the third condition is satisfied when the conditions for the length ratios LS1/LS2 and LS3/LS4 and the conditions for the angles θ1 to θ4 are both satisfied.

The control section 110 determines whether the third condition is satisfied based on the shape of the imaging target region AR0 included in the frames FR0, as described above. When the third condition is not satisfied, the control section 110 outputs guidance for satisfying the third condition in S108 shown in FIG. 5. As an example of the output of the guidance, “Please hold the camera so as to face the test pattern.”, or any other piece of information may be displayed or verbally output.

FIG. 9 diagrammatically shows an example of whether the fourth condition is satisfied, the fourth condition being a condition that the amount of distortion DS indicating the distortion of the test pattern TP0 included in the frames FR0 is smaller than or equal to the threshold THDS. As shown in the middle portion of FIG. 9, the shape of the test pattern TP0 included in the frames FR0 may be distorted from the shape of the test pattern TP0 on the medium ME0 shown in the upper portion of FIG. 9. The control section 110 can determine whether the fourth condition is satisfied based on the shape of the test pattern TP0 included in the frames FR0. The threshold THDS is an example of the reference amount of distortion and is a positive value.

When the region of the test pattern TP0 has a rectangular shape and the test pattern TP0 is included in the frames FR0, the control section 110 can determine the interval between adjacent corners C1 in the quadrangular region of the test pattern TP0 included in the frames FR0 based on the frames FR0. FIG. 9 shows lengths LT1 and LT2 corresponding to the vertical sides, and lengths LT3 and LT4 corresponding to the horizontal sides. The amount of the distortion DS of the vertical sides can be expressed, for example, by LT1/LT2 when LT1>LT2 is satisfied, and LT2/LT1, which is a value greater than one, when LT1<LT2 is satisfied. The amount of the distortion DS of the lateral sides can be expressed, for example, by LT3/LT4 when LT3>LT4 is satisfied, and LT4/LT3, which is a value greater than one, when LT3<LT4 is satisfied. On the assumption that the threshold THDS is set at a value greater than one, and when the amount of the distortion DS of the vertical sides is smaller than or equal to the threshold THDS, and the amount of the distortion DS of the horizontal sides is smaller than or equal to the threshold THDS, the control section 110 determines that the fourth condition is satisfied. The threshold THDS is not limited to a specific value and can be set, for example, at 1.2. When the amount of the distortion DS of the vertical sides is greater than the threshold THDS or the amount of the distortion DS of the horizontal sides is greater than the threshold THDS, the control section 110 determines that the fourth condition is not satisfied.

A percentage may, of course, be used in place of the length ratio.

The control section 110 may determine angles α1, α2, α3, and α4 of the four corners C1 of the quadrangular region of the test pattern TP0 based on the frames FR0. The amount of the distortion DS of the four corners C1 can be expressed, for example, by differences |α1−90°|, |α2−90°|, |α3−90°|, and |α4−90°| between the angles α1, α2, α3, and α4 and the angle of 90°. For example, on the assumption that the threshold value THDS is a value greater than 0° but smaller than 45°, and when the differences |α1−90°|, |α2−90°|, |α3−90°|, and |α4−90°| are all smaller than or equal to the threshold value THDS, the control section 110 can determine that the fourth condition is satisfied. When at least one of the differences |α1−90°|, |α2−90°|, |α3−90°|, and |α4−90°| is greater than the threshold THDS, the control section 110 can determine that the fourth condition is not satisfied.

Note that the control section 110 may determine that the fourth condition is satisfied when the conditions for the length ratios LT1 to LT4 and the conditions for the angles α1 to α4 are both satisfied.

Furthermore, when the rectangular medium ME0 is included in the frames FR0, the control section 110 may determine the angles θ1, θ2, θ3, and θ4 of the four corners C0 of the medium ME0 based on the frames FR0 as shown in FIG. 8. The amount of the distortion DS of the four corners C0 can be expressed, for example, by differences |θ1−90°|, |θ2−90°|, |θ3−90°|, and |θ4−90°| between the angles θ1, θ2, θ3, and θ4 and the angle of 90°. When the differences are each smaller than or equal to the threshold THDS, the control section 110 can determine that the fourth condition is satisfied. When at least one of the differences |θ1−90°|, |θ2−90°|, |θ3−90°|, and |θ4−90°| is greater than the threshold THDS, the control section 110 can determine that the fourth condition is not satisfied.

The control section 110 thus determines whether the fourth condition is satisfied based on the shape of the test pattern TP0 included in the frames FR0. When the fourth condition is not satisfied, the control section 110 outputs guidance for satisfying the fourth condition in S108 shown in FIG. 5. As an example of the output of the guidance, “Please hold the camera in such a way that the test pattern is not distorted.”, or any other piece of information may be displayed or verbally output.

FIG. 10 diagrammatically shows an example of whether the fifth condition is satisfied, the fifth condition being a condition that the length of the interval D corresponding to the interval between the imaging section 120 and the medium ME0 is smaller than or equal to the threshold THD. The threshold THD is an example of the reference length of the interval and is a positive value.

The control section 110 determines whether the imaging target region AR0 is included in the frames FR0, as described above. When the imaging target region AR0 is included in the frames FR0, the control section 110 can determine an area Sa of the imaging target region AR0 based on the frames FR0. Let now Sf be the area of each of the frames FR0. An area ratio Sa/Sf of the imaging target region AR0 to each of the frames FR0 increases as the imaging section 120 approaches the medium ME0 and decreases as the imaging section 120 moves away from the medium ME0. Since the maximum value of the area ratio Sa/Sf is one, the length of the interval D can be expressed by 1−(Sa/Sf).

When the information terminal 1 includes the sensor SS2, for example, a distance measuring sensor, the control section 110 may acquire a value detected by the sensor SS2, for example, the distance from the imaging section 120 to the medium ME0 as the length of the interval D.

The control section 110 can determine whether the fifth condition is satisfied based on the acquired length of the interval D. When the length of the interval D is smaller than or equal to the threshold THD, the control section 110 determines that the fifth condition is satisfied. When the length of the interval D is greater than the threshold THD, the control section 110 determines that the fifth condition is not satisfied. Since the first condition is not satisfied when the length of the interval D is extremely close to zero, the threshold THD indicating the upper limit of the length of the interval D suffices.

Note that the control section 110 may determine that the fifth condition is satisfied when the condition based on the area ratio Sa/Sf and the condition based on the value detected by the sensor SS2 are both satisfied.

When the fifth condition is not satisfied, the control section 110 outputs guidance for satisfying the fifth condition in S108 shown in FIG. 5. As an example of the output of the guidance, “Please hold the camera closer to the test pattern.”, or any other piece of information may be displayed or verbally output.

FIGS. 11A and 11B diagrammatically show an example of whether the sixth condition is satisfied, the sixth condition being a condition that the magnitude of the brightness L0 indicating the brightness L of the ground color of the medium ME0 is greater than or equal to the threshold THL. The brightness L may be a luminance value determined from the pixel values of any of the frames FR0, for example, the average of R (red) values, G (green) values, and B (blue) values at the pixels, a lightness value determined from the pixel values of any of the frames FR0, or the like. The threshold THL is an example of the reference magnitude of the brightness and is a positive value.

In general, the ground color of the medium ME0 is brighter than that of the test pattern TP0. A graph of the number of pixels Np versus the brightness L in any of the frames FR0 provided from the imaging section 120 facing the medium ME0 shows a peak Pl at brightness LP1 corresponding to the ground color of the medium ME0 and a peak P2 at the brightness corresponding to the test pattern TP0. The peak P1 is located at a position where the brightness is higher than that at the position of the peak P2. When the brightness LP1 corresponding to the peak P1 represents the magnitude of the brightness L0, the threshold for the magnitude of the brightness L0 can be THL, as shown in FIG. 11A. The threshold THL is a positive value smaller than the upper limit of the brightness L. When the magnitude of the brightness L0 is greater than or equal to the threshold THL, the control section 110 can determine that the sixth condition is satisfied. When the magnitude of the brightness L0 is smaller than the threshold THL, the control section 110 can determine that the sixth condition is not satisfied.

Note that the peak Pl at the brightness LP1 may be replaced with a statistical representative value such as the average of the number of pixels Np at the brightness L where the number of pixels Np exceeds a predetermined value.

The control section 110 may determine a graph area St in the region greater than or equal to a positive threshold THS smaller than the upper limit of the brightness L, for example, the sum of the number of pixels Np in the region greater than or equal to the threshold THS, as shown in FIG. 11B. The area St becomes greater as the ground color of the medium ME0 becomes brighter, and becomes smaller as the ground color of the medium ME0 becomes darker. In view of the fact described above, when the area St represents the magnitude of the brightness L0, the threshold for the magnitude of the brightness L0 can be THL. The threshold THL is a positive value smaller than the entire graph area Sh, for example, the number of pixels of any of the frames FR0. The area ratio St/Sh of the region greater than or equal to the threshold THS to the entire graph becomes greater as the ground color of the medium ME0 becomes brighter, and becomes smaller as the ground color of the medium ME0 becomes darker. In view of the fact described above, when the area ratio St/Sh represents the magnitude of the brightness L0, the threshold for the magnitude of the brightness L0 can be THL. The threshold THL is a positive value smaller than one. A percentage expressed by 100×St/Sh (%) may, of course, be used in place of the area ratio St/Sh.

When the magnitude of the brightness L0 is greater than or equal to the threshold THL, the control section 110 can determine that the sixth condition is satisfied. When the magnitude of the brightness L0 is smaller than the threshold THL, the control section 110 can determine that the sixth condition is not satisfied.

Furthermore, the determination of the sixth condition may be performed by a known method other than the method described above.

The control section 110 thus acquires the magnitude of the brightness L0 of the ground color of the medium ME0 based on the frames FR0, and determines whether the sixth condition is satisfied based on the acquired magnitude of the brightness L0. When the sixth condition is not satisfied, the control section 110 outputs guidance for satisfying the sixth condition in S108 shown in FIG. 5. As an example of the output of the guidance, “Please place the test pattern in a bright environment.”, or any other piece of information may be displayed or verbally output.

FIG. 12 diagrammatically shows an example of criteria used to determine the imaging condition. The control section 110 determines whether multiple conditions out of the six conditions are satisfied, and acquires the captured image IM0 by causing the imaging section 120 to image the imaging target region AR0 in response to a trigger that is satisfaction of the multiple conditions. The imaging condition may be the logical conjunction of the six conditions, but may not include the third condition, the fourth condition, the fifth condition, or the sixth condition as long as the imaging condition includes the first and second conditions.

In the present specific example, since imaging is performed in response to a trigger that is satisfaction of at least the first and second conditions, the imaging range is appropriate, and the captured image IM0 having a small amount of blur is produced. The present specific example therefore allows an appropriate captured test pattern image to be used to adjust the printing characteristics, and can prevent a situation in which an unnecessary captured image wastes a certain amount of capacity of the memory.

The control section 110 can acquire adjustment values used to adjust the printing characteristics of the printing apparatus 2 based on the pixel values of the test pattern TP0 included in the captured image IM0. When the test pattern TP0 is the density pattern used to adjust the density of the print image PI0, the control section 110 can acquire density adjustment values used to adjust the density of the print image PI0 based on the pixel values of the test pattern TP0. When the test pattern TP0 is the Bi-d adjustment pattern for the Bi-d adjustment, the control section 110 can acquire Bi-d adjustment values used to perform the Bi-d adjustment based on the pixel values of the test pattern TP0. When the test pattern TP0 is the transportation length adjustment pattern used to adjust the transportation length of the medium ME0, the control section 110 can acquire transportation length adjustment values used to adjust the transportation length of the medium ME0 based on the pixel values of the test pattern TP0.

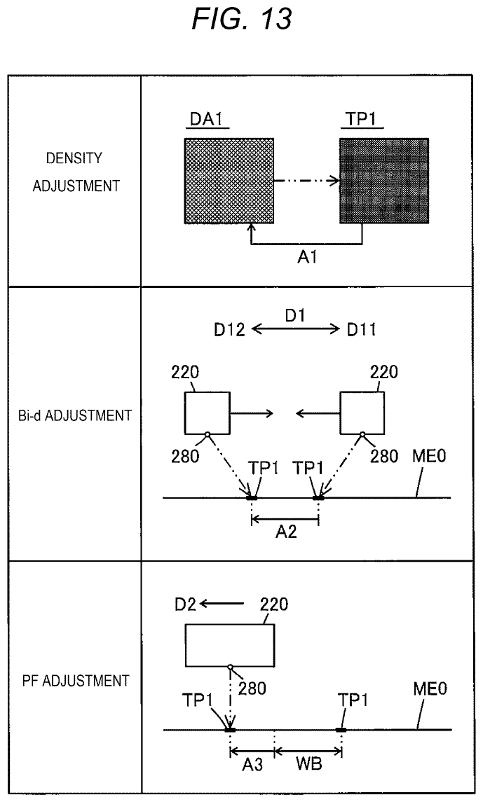

FIG. 13 diagrammatically shows an example of the adjustment of the printing characteristics.

The density adjustment means setting an adjustment value A1 used to adjust the density of the print image PI0 to the density of an input image. For example, it is assumed that the print image PI0 is denser than the input image, as shown in FIG. 13. In this case, the output density of any of the individual patterns TP1 is higher than the density of individual pattern data DA1 used to form the individual pattern TP1. For example, the control section 110 can cause the printing apparatus 2 to perform the density adjustment by setting the adjustment value A1, which corresponds to the deviation of the output density of the individual pattern TP1 from the density of the individual pattern data DA1, in the controller 210 of the printing apparatus 2. The controller 210 can adjust the density of the print image PI0 to the density of the input image by lowering the output density of the individual pattern TP1 corresponding to the individual pattern data DA1 to the density of the individual pattern data DA1 in accordance with the adjustment value A1. Of course, even when the density of the print image PI0 is lower than that of the input image, the density of the print image PI0 can be adjusted to the density of the input image by setting the adjustment value A1.

The Bi-d adjustment means setting an adjustment value A2 used to align the landing positions of the droplets 280 along the forward path and the landing positions of the droplets 280 along the backward path in a primary scan direction D1 when the printing apparatus 2 repeats the primary scan and the secondary scan during printing. The forward path means the primary scan in which the recording head 220 moves in a forward direction D11, and the backward path means the primary scan in which the recording head 220 moves in a backward direction D12. It is, for example, assumed that the landing positions in the backward path to be aligned with the landing positions in the forward path in the primary scan direction DI are shifted in the forward direction D11 from the landing positions in the forward path, as shown in FIG. 13. In this case, the position of each of the individual patterns TP1 formed on the medium ME0 in the backward path deviates in the forward direction D11 from the position of the individual pattern TP1 formed on the medium ME0 in the forward path. For example, the control section 110 can cause the printing apparatus 2 to perform the Bi-d adjustment by setting the adjustment value A2, which corresponds to the deviation of the position of the individual pattern TP1, in the controller 210 of the printing apparatus 2. The controller 210 can delay the discharge timing of the droplets 280 from the recording head 220 in the backward path in accordance with the adjustment value A2 to align the landing positions of the droplets 280 in the forward path with those in the backward path in the primary scan direction D1. Of course, when the landing positions in the backward path to be aligned with the landing positions in the forward path in the primary scan direction DI are shifted in the backward direction D12 from the landing positions in the forward path as well, the landing positions of the droplets 280 in the forward path can be aligned with those in the backward path in the primary scan direction D1 by setting the adjustment value A2.

PF adjustment as the transportation length adjustment means setting an adjustment value A3 used to exactly adjust the transportation length of the medium ME0 during the secondary scan in a secondary scan direction D2. The secondary scan direction D2 means the direction in which the recording head 220 moves relative to and with respect to the medium ME0, and the transport direction in which the medium ME0 moves relative to and with respect to the recording head 220 is the opposite direction of the secondary scan direction D2. Too large a transportation length of the medium ME0 during the secondary scan produces a streak that is a gap generated between band regions, for example, a light streak, and too small a transportation length of the medium ME0 during the secondary scan produces a streak that is dots overlapping with each other between band regions, for example, a dark streak. It is, for example, assumed that the interval between the inter-secondary-scan landing positions of the droplets 280 in the secondary scan direction D2 is greater than a width WB of a theoretical band region, as shown in FIG. 13. In this case, the interval between the individual pattern TP1 formed on the medium ME0 in a certain pass and the individual pattern TP1 formed on the medium ME0 in the previous pass is greater than the width WB of the band region. The control section 110 can, for example, cause the printing apparatus 2 to perform the PF adjustment by setting the adjustment value A3, which corresponds to the deviation of the interval between the individual patterns TP1 from the width WB of the band region, in the controller 210 of the printing apparatus 2. The controller 210 can exactly adjust the transportation length of the medium ME0 during the secondary scan in the secondary scan direction D2 by reducing the transportation length of the medium ME0 during the secondary scan in accordance with the adjustment value A3. Of course, when the interval between the inter-secondary-scan landing positions of the droplets 280 in the secondary scan direction D2 is smaller than the width WB of the theoretical band region as well, the transportation length of the medium ME0 during the secondary scan can be exactly adjusted by setting the adjustment value A3.

As described above, the user US1 can readily adjust the various printing characteristics by imaging the test pattern TP0 with the portable information terminal 1 such as a camera-equipped portable terminal.

### (4) Variations

There are various conceivable variations of the present disclosure.

The processes described above can be changed as appropriate, for example, the order of the processes can be changed. For example, in the imaging control shown in FIG. 5, the process of acquiring the condition satisfaction determination information in S104 can be carried out before the process in S102. Furthermore, even when the process of outputting guidance in S108 is not carried out, the effect of enabling imaging an appropriate test pattern is provided.

The imaging may be repeatedly performed when the imaging condition is satisfied, as shown in FIG. 14. FIG. 14 diagrammatically shows an example of continuous imaging control performed by the control section 110. The continuous imaging control starts when the control section 110 accepts a continuous imaging instruction that instructs imaging the imaging target region AR0 via the operation section 115. The continuous imaging instruction may be an operation on a continuous imaging instruction region displayed after the imaging control program PR0 is activated, an operation on the shutter button, the operation of activating the imaging control program PR0, or the like.

When the continuous imaging control starts, the control section 110 accepts, via the operation section 115, an input of the number of times Nt the imaging target region AR0 is repeatedly imaged (S202). The number of times Nt is an integer greater than or equal to one, and when the continuous imaging is intended, the number of times Nt is an integer greater than or equal to two. The control section 110 then carries out the processes in S102 to S110 shown in FIG. 5 to acquire the captured image IM0 by causing the imaging section 120 to image the imaging target region AR0 in response to a trigger that is satisfaction of the imaging condition.

After acquiring the captured image IM0, the control section 110 determines whether the imaging target region AR0 has been imaged Nt times (S204). When the imaging target region AR0 has been only imaged less than Nt times, the control section 110 carries out the processes in S102 to S110 shown in FIG. 5 again. The control section 110 thus causes the imaging section 120 to repeatedly image the imaging target region AR0 Nt times when the imaging condition is satisfied.

When the imaging target region AR0 is imaged Nt times, the control section 110 determines whether to save the Nt captured images IM0 as the file FL0 (S206). For example, when the operation section 115 accepts the operation of saving the captured images IM0, the control section 110 changes the format of the captured images IM0 to the format of the file FL0, saves the resultant captured images IM0 in the storage 114 (S208), and terminates the continuous imaging control. When the operation section 115 accepts the operation of discarding the captured images IM0, the control section 110 terminates the continuous imaging control without carrying out the saving process in S208.

An appropriate captured test pattern image is thus produced multiple times, so that the printing characteristics can be more appropriately adjusted.

### (5) Conclusions

The various aspects of the present disclosure can provide a configuration and the like capable of imaging an appropriate test pattern, as described above. The basic effects and advantages described above can, of course, also be provided by aspects including only constituent requirements according to the independent claims.

In addition, it is conceivable to employ a configuration in which the elements disclosed in the examples described above are interchanged with each other or the combination of the elements is changed, a configuration in which the elements disclosed in known technologies and the examples described above are interchanged with each other or the combination of the elements is changed, and the like. The present disclosure also includes the configurations described above and the like.

What is claimed is:

1. A non-transitory computer-readable storage medium storing an imaging control program for imaging a medium having a test pattern used to adjust printing characteristics of a printing apparatus including a recording head, the program configured to cause a computer to realize
a determination function of determining whether an imaging condition that causes an imaging section to image an imaging target region including the test pattern is satisfied; and
an imaging control function of causing the imaging section to image the imaging target region in response to a trigger that is satisfaction of the imaging condition to acquire a captured image,
wherein the determination function repeatedly acquires an amount of a change in a relative positional relationship between the imaging section and the medium,
the imaging condition includes at least first and second conditions to be satisfied, the first condition being a condition that the imaging target region falls within a viewing angle of the imaging section, the second condition being a condition that the acquired amount of the change is smaller than or equal to a reference amount of the change, and
the determination function determines whether the first condition is satisfied based on frames repeatedly acquired from the imaging section, and determines whether the second condition is satisfied based on the acquired amount of the change.

2. The non-transitory computer-readable storage medium storing the imaging control program according to claim 1, wherein
the imaging condition includes at least the first condition, the second condition, and a third condition to be satisfied, the third condition being a condition that the imaging section falls within a predetermined range over which the imaging section faces the imaging target region, and
the determination function determines whether the third condition is satisfied based on a shape of the imaging target region included in the frames.

3. The non-transitory computer-readable storage medium storing the imaging control program according to claim 1, wherein
the imaging condition includes at least the first condition, the second condition, and a fourth condition to be satisfied, the fourth condition being a condition that an amount of distortion indicating distortion of the test pattern included in the frames is smaller than or equal to a reference amount of the distortion, and
the determination function determines whether the fourth condition is satisfied based on a shape of the test pattern included in the frames.

4. The non-transitory computer-readable storage medium storing the imaging control program according to claim 1, wherein
the determination function repeatedly detects a length of an interval corresponding to an interval between the imaging section and the medium,
the imaging condition includes at least the first condition, the second condition, and a fifth condition to be satisfied, the fifth condition being a condition that the length of the interval is smaller than or equal to a reference length of the interval, and
the determination function determines whether the fifth condition is satisfied based on the detected length of the interval.

5. The non-transitory computer-readable storage medium storing the imaging control program according to claim 1, wherein
the determination function acquires an amount of brightness of a ground color of the medium based on the frames,
the imaging condition includes at least the first condition, the second condition, and a sixth condition to be satisfied, the sixth condition being a condition that the amount of the brightness is greater than or equal to a reference amount of the brightness, and
the determination function determines whether the sixth condition is satisfied based on the acquired amount of the brightness.

6. The non-transitory computer-readable storage medium storing the imaging control program according to claim 1, wherein
the imaging condition includes at least
the first condition,
the second condition,
a third condition that the imaging section falls within a predetermined range over which the imaging section faces the imaging target region,
a fourth condition that an amount of distortion indicating distortion of the test pattern included in the frames is smaller than or equal to a reference amount of the distortion,
a fifth condition that a length of the interval corresponding to an interval between the imaging section and the medium is smaller than or equal to a reference length of the interval, and
a sixth condition that an amount of the brightness indicating brightness of a ground color of the medium based on the frames is greater than or equal to a reference amount of the brightness,
the determination function
determines whether the third condition is satisfied based on a shape of the imaging target region included in the frames,
determines whether the fourth condition is satisfied based on a shape of the test pattern included in the frames,
repeatedly detects the length of interval, and determines whether the fifth condition is satisfied based on the detected length of the interval, and
acquires the amount of brightness, and determines whether the sixth condition is satisfied based on the acquired amount of the brightness.

7. The non-transitory computer-readable storage medium storing the imaging control program according to claim 1, wherein the imaging control function accepts an input of a number of times the imaging target region is repeatedly imaged, and causes the imaging section to repeatedly image the imaging target region the number of times described above when the imaging condition is satisfied.

8. The non-transitory computer-readable storage medium storing the imaging control program according to claim 1, further causing the computer to realize a guidance function of outputting, when any of multiple conditions included in the imaging condition is not satisfied, guidance for satisfying the unsatisfied condition.

9. A printing system comprising: a printing apparatus including a recording head; and an information terminal configured to image a medium having a test pattern used to adjust printing characteristics of the printing apparatus, wherein
the information terminal includes
an imaging section, and
a control section including a memory configured to store a captured image provided from the imaging section and configured to cause the imaging section to image an imaging target region including the test pattern,
the control section is configured to repeatedly acquire an amount of a change in a relative positional relationship between the imaging section and the medium, determine whether an imaging condition that causes the imaging section to image the imaging target region is satisfied, and cause the imaging section to image the imaging target region in response to a trigger that is satisfaction of the imaging condition to acquire the captured image,
the imaging condition includes at least first and second conditions to be satisfied, the first condition being a condition that the imaging target region falls within a viewing angle of the imaging section, the second condition being a condition that the acquired amount of the change is smaller than or equal to a reference amount of the change, and
the control section is configured to determine whether the first condition is satisfied based on frames repeatedly acquired from the imaging section, and determine whether the second condition is satisfied based on the acquired amount of the change.
